(19) United States
(12) Patent Application Publication
(10) Pub. No.: US 2007/0075035 A1
(43) Pub. Date: Apr. 5, 2007

(54) Method for microstructuring surfaces of a workpiece and its use

(76) Inventors: Gernot Repphun, Balingen (DE); Martin Voss, Gerlingen (DE); Frank Wrona, Stuttgart (DE)

Correspondence Address: KENYON & KENYON LLP, ONE BROADWAY, NEW YORK, NY, 10004, US

(21) Appl. No.: 11/541,019

(22) Filed: Sep. 29, 2006

(30) Foreign Application Priority Data
Sep. 30, 2005 (DE) 102005047082.3

(51) Int. Cl. B44C 1/22

(52) U.S. Cl. 216/53; 216/52

(57) ABSTRACT

A method for microstructuring surfaces of a workpiece includes the following steps: a) placing a workpiece to be structured into a liquid medium; b) providing a light source for producing a cavitation bubble in the liquid medium; and c) producing a cavitation bubble using the light source in such a way that the subsequent collapse of the cavitation bubble structures the surface of the workpiece, in particular material is removed from the surface.

### BACKGROUND INFORMATION

A laser may be used for structuring a workpiece in the micro range. The laser produces a fine laser beam which is focused on the surface of the workpiece to be structured and affects the focused point with such heat that the workpiece melts at that point. The molten material of the workpiece may be easily removed.

German Patent Application No. DE 4224282, for example, describes a method for microstructuring and removal of glass, the glass being irradiated by a pulsed solid-state laser. According to its teaching, the structures thus produced may have a width as small as 10 μm. When structures in the micro range are formed by melting the material, it is, however, basically disadvantageous that bulges are formed at the same time at the edges of the microstructures. If these bulges are no longer negligibly small, they must be removed in a separate work step.

Another option for producing microstructures on surfaces of a workpiece is to introduce recesses into the surfaces with the aid of forced cavitation. Cavitation is understood as the formation of vapor bubbles in liquids. Vapor bubbles are preferably formed at a low pressure. As is known, low pressure reduces the boiling point of a liquid. If the boiling point is reduced to such a degree that it is lower than the temperature of the liquid at the moment, the above-mentioned vapor bubbles are formed. If the pressure rises again, these bubbles disintegrate, i.e., implode or collapse. The collapse of the bubbles causes an enormous pressure wave, which is also known as liquid shock or microjets. Workpieces exposed to these pressure waves cannot withstand the high pressure stresses, which modify their surfaces.

German Patent Application No. DE 10314447 uses a method based on the above-described effect for removing material from the surfaces of workpieces and thus for achieving microstructuring. Ultrasonic waves or liquid jets are provided for producing the cavitation. Material may thus be removed for microstructuring the workpiece without bulges being formed at the same time at the edges of the microstructures.

However, it is not possible,to control ultrasonic waves or liquid jets as accurately as a finely focused laser beam, which ensures more precise machining of workpieces.

### SUMMARY OF THE INVENTION

The method according to the present invention and its use have the advantage that very accurately positioned microstructures may be produced on workpiece surfaces without bulges forming at the edges of the microstructures. Since the surfaces are not melted during the method, the texture in the area of the workpiece near the surface remains unchanged. These workpieces are also well suited as test objects in research.

The method furthermore advantageously makes it possible to adjust the size of the cavitation bubbles to be produced in a simple manner. The possibility of adjusting the size (radius) of the cavitation bubbles allows more controlled structuring of the surfaces.

### BRIEF DESCRIPTION OF THE DRAWINGS

FIG. 1 shows an exemplary embodiment of the method according to the present invention using a laser for producing a cavitation bubble.

FIG. 2 shows a collapsed cavitation bubble and resulting cavitation erosion (recess on the surface).

### DETAILED DESCRIPTION

The method of the present invention for microstructuring the surfaces of a workpiece basically includes the following steps:
a) placing a workpiece to be structured in a liquid medium,
b) providing a light source for producing a cavitation bubble in the liquid medium, and
c) producing a cavitation bubble using the light source in such a way that the surface of the workpiece is structured, in particular material is removed from the surface, due to the subsequent collapse of the cavitation bubble.

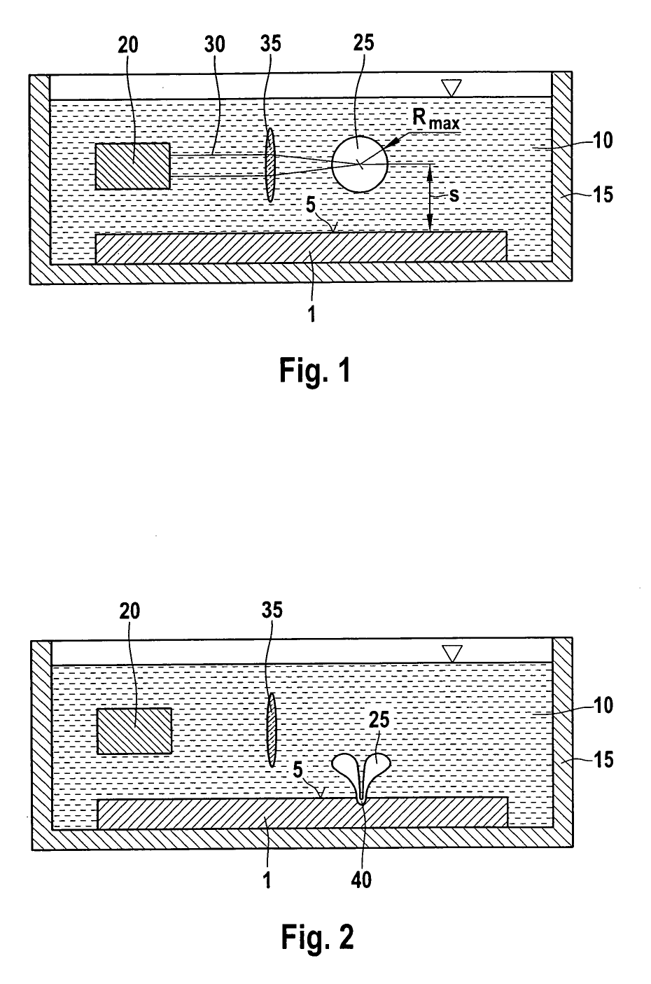

FIG. 1 shows a workpiece 1 having a surface 5 to be structured, workpiece 1 being situated in a container 15 filled with a liquid medium 10. This corresponds to step a) of the method. Water, in particular distilled water, is preferably used as liquid medium 10.

Furthermore, according to step b), a light source 20 is provided for producing a cavitation bubble 25. Light source 20 is also immersed in liquid medium 10 in this example. However, in general, light source 20, contrary to workpiece 1, may be immersed in liquid medium 10 partially or not at all. It is only important that light source 20 generates a light beam 30, which may be used for forming a cavitation bubble 25 in liquid medium 10. In this example, light source 20 is formed by a laser. Using a lens system 35, which includes at least one focusing lens, the laser beam may be focused in space and positioned very accurately.

In a step c), a laser beam is formed via a laser pulse of the laser, whereby a vapor bubble growing to a maximum bubble radius Rₘₐₓ is initially produced as cavitation bubble 25 (“shooting cavitation bubble 25”). Maximum radius Rₘₐₓ of the vapor bubble may be advantageously adjusted by varying the intensity and/or pulse duration of the laser. The vapor bubble is usually not produced directly at the point of machining of workpiece 1, but a short distance s>0 away from surface 5 of workpiece 1. For this purpose, the laser beam is simply focused onto a point at a distance s>0 from surface 5 of workpiece 1. In other words: The point where cavitation bubble 25 is produced is simply the same as the point focused by the laser beam.

After reaching maximum size, cavitation bubble 25 collapses (FIG. 2). Distance s is selected such that a pressure pulse, formed when cavitation bubble 25 collapses, reaches surface 5 of workpiece 1 and structures surface 5. The material on surface 5 of workpiece 1 may be deformed and/or removed from surface 5 by the pressure pulse. The deformation and/or the material removal are reproducible in particular when the s/Rₘₐₓ ratio is less than or equal to 0.9. In order to meet this condition, distance s—as mentioned above—may be varied via a suitable selection of the focus point of the laser. When using a laser, it is also possible to adjust its intensity and/or pulse duration in such a way that Rₘₐₓ attains a suitable value.

Of course, step c) may be repeated multiple times in a structuring process until an intended amount of material is removed and thus recess 40 has attained a desired size or volume at the site of machining. Recess 40 typically has the shape of a crater whose diameter is approximately of the order of magnitude of cavitation bubble 25. The center of the crater overlaps with the center of cavitation bubble 25 in a top view onto surface 5 of workpiece 1. Since it has been established that the position of cavitation bubble 25 to be produced may be precisely adjusted using the laser, localized structuring of surface 5 is therefore possible.

The above-described method may be very advantageously used for surface treatment of a workpiece 1 for reducing friction and/or wear due to tribologic loads. For example, lubricants may be introduced in recesses 40 that have been produced to counteract tribologic loads.

What is claimed is:

1. A method for microstructuring at least one surface of a workpiece, comprising:
a) placing the workpiece to be structured into a liquid medium;
b) providing a light source for producing a cavitation bubble in the liquid medium; and
c) producing the cavitation bubble using the light source in such a way that a subsequent collapse of the cavitation bubble structures the surface of the workpiece.

2. The method according to claim 1, wherein step c) includes removing material from the surface.

3. The method according to claim 1, wherein the liquid medium includes water.

4. The method according to claim 3, wherein the water is distilled water.

5. The method according to claim 1, wherein the light source includes a laser.

6. The method according to claim 5, wherein a focused laser beam is formed via a laser pulse of the laser in step c), a vapor bubble initially growing to a maximum bubble radius Rₘₐₓ being produced as the cavitation bubble.

7. The method according to claim 6, wherein the cavitation bubble is produced at a distance s>0 from the surface of the workpiece in step c).

8. The method according to claim 7, wherein the laser beam is focused onto a point at a distance s>0 from the surface of the workpiece in step c).

9. The method according to claim 7, wherein the distance s is selected in step c) such that a pressure pulse formed when the cavitation bubble collapses reaches the surface of the workpiece and structures the surface.

10. The method according to claim 7, wherein with respect to the laser, at least one of its intensity and pulse duration is selected in step c) such that the s/Rₘₐₓ ratio is less than or equal to 0.9.

11. The method according to claim 1, wherein step c) is repeated a plurality of times.

12. The method according to claim 1, wherein the method is used for a surface treatment of the workpiece for reducing at least one of a friction and a wear due to tribologic loads.
